(19) United States
(12) Patent Application Publication
(10) Pub. No.: US 2003/0043338 A1
(43) Pub. Date: Mar. 6, 2003

(54) Method of manufacturing one drop fill liquid crystal display panel

(76) Inventors: Louis Liou, Taoyuan Hsien (TW); Tanaka Sakae, Taoyuan Hsien (TW); Ching Chao Chang, Taipei City (TW)

Correspondence Address: MERCHANT & GOULD PC, P.O. BOX 2903, MINNEAPOLIS, MN, 55402-0903, US

(21) Appl. No.: 10/093,581

(22) Filed: Mar. 8, 2002

(30) Foreign Application Priority Data
Sep. 3, 2001 (TW) 90121738

(51) Int. Cl. G02F 1/1343

(52) U.S. Cl. 349/189

(57) ABSTRACT

A method of manufacturing a one drop fill liquid crystal display (ODF LCD) panel is disclosed. By separating sealant and black matrix using a space or photo spacer, the sealant can be hardened by applying ultraviolet light from the side of the color filter substrate without light shielding problems. Moreover, this also completely hardens the sealant, thereby preventing pollution of the liquid crystal material. This further improves the efficiency of the liquid crystal material.

### BACKGROUND OF THE INVENTION

1. Field of the Invention

The present invention relates in general to a method of manufacturing a liquid crystal display (LCD) panel. In particular, the present invention relates to a method of manufacturing a one drop fill (ODF) LCD panel.

2. Description of the Related Art

FIG. 1a is a perspective view showing a conventional one drop fill liquid crystal display (ODF LCD) panel, FIG. 1b is a sectional view showing the conventional ODF LCD panel. In FIGS. 1a and 1b, a color pixel area 3, a black matrix 5 and a sealant 7 are respectively positioned on the surface of a color filter substrate 1, and a liquid crystal material 8 is located on a array substrate 9. In the process of manufacturing a conventional ODF LCD panel, it is necessary to apply ultraviolet light (UV light, not shown) to harden the sealant 7 while superposing the color filter substrate 1 and the array substrate 9. However, when the UV light is applied from the side of the array substrate 9, the UV light is partly shielded by the circuits of the array substrate 9. As a result, the sealant 7 can't completely harden. This may cause the liquid crystal material 8 to become polluted and decrease the efficiency of the liquid crystal material 8. On the other hand, when the UV light is applied from the side of the color filter substrate 1, the UV light is still partly shielded by the black matrix 5 of the color filter substrate 1. As a result, the sealant 7 can't completely harden, once again raising the possibility that the liquid crystal material 8 will become polluted and decrease the efficiency of the liquid crystal material 8.

### SUMMARY OF THE INVENTION

The present invention is intended to overcome the above-described disadvantages.

The present invention provides a first method of manufacturing a one drop fill liquid crystal display panel, including the steps of: providing a first substrate and a second substrate, the first substrate having a first central region and a first peripheral region, and the second substrate having a second central region and a second peripheral region, wherein a color pixel area and a black matrix area are positioned on the surface of the first central region, and the first central region and the first peripheral region are positioned opposite to the second central region and the second peripheral region respectively; forming a sealant area on the first peripheral region, wherein the sealant area is located at the outside of the black matrix area and separated from the black matrix area by a predetermined space; dispersing at least one drop of a liquid crystal on the second central region; superposing the first substrate and the second substrate under a condition of reduced ambient air pressure; and curing the sealant area by applying ultraviolet light from a side of the first substrate.

The present invention further provides a second method of manufacturing a one drop fill liquid crystal display panel, including the steps of: providing a first substrate and a second substrate, the first substrate having a first central region and a first peripheral region, and the second substrate having a second central region and a second peripheral region, wherein a color pixel area and a black matrix area are positioned on the surface of the first central region, and the first central region and the first peripheral region are positioned opposite to the second central region and the second peripheral region respectively; forming a sealant area on the second peripheral region, wherein the sealant area is located opposite to the outside of the black matrix area and separated from the black matrix area by a predetermined space; dispersing at least one drop of a liquid crystal on the second central region; superposing the first substrate and the second substrate under a condition of reduced ambient air pressure; and curing the sealant area by applying ultraviolet light from a side of the first substrate.

The present invention further provides a third method of manufacturing a one drop fill liquid crystal display panel, including the steps of: providing a first substrate and a second substrate, the first substrate having a first central region and a first peripheral region, and the second substrate having a second central region and a second peripheral region, wherein a color pixel area and a black matrix area are positioned on the surface of the first central region, and the first central region and the first peripheral region are positioned opposite to the second central region and the second peripheral region respectively; forming a photo spacer area on the first peripheral region, wherein the photo spacer area overlaps the outside edge of the black matrix area; forming a sealant area on the first peripheral region, wherein the sealant area is located at the outside of the photo spacer area; dispersing at least one drop of a liquid crystal on the second central region; superposing the first substrate and the second substrate under a condition of reduced ambient air pressure; and curing the sealant area by applying ultraviolet light from a side of the first substrate.

The present invention further provides a fourth method of manufacturing a one drop fill liquid crystal display panel, including the steps of: providing a first substrate and a second substrate, the first substrate having a first central region and a first peripheral region, and the second substrate having a second central region and a second peripheral region, wherein a color pixel area and a black matrix area are positioned on the surface of the first central region, and the first central region and the first peripheral region are positioned opposite to the second central region and the second peripheral region respectively; forming a photo spacer area on the first peripheral region, wherein the photo spacer area overlaps the outside edge of the black matrix area; forming a sealant area on the second peripheral region, wherein the sealant area is located opposite to the outside of the photo spacer area; dispersing at least one drop of a liquid crystal on the second central region; superposing the first substrate and the second substrate under a condition of reduced ambient air pressure; and curing the sealant area by applying ultraviolet light from a side of the first substrate.

The present invention further provides a fifth method of manufacturing a one drop fill liquid crystal display panel, including the steps of: providing a first substrate and a second substrate, the first substrate having a first central region and a first peripheral region, and the second substrate having a second central region and a second peripheral region, wherein a color pixel area and a black matrix area are positioned on the surface of the first central region, and the first central region and the first peripheral region are positioned opposite to the second central region and the second peripheral region respectively; forming a photo spacer area on the second peripheral region, wherein the photo spacer area is located at a first position opposite to the outside edge of the black matrix area; forming a sealant area on the first peripheral region, wherein the sealant area is located at a second position opposite to the outside of the photo spacer area; dispersing at least one drop of a liquid crystal on the second central region; superposing the first substrate and the second substrate under a condition of reduced ambient air pressure; and curing the sealant area by applying ultraviolet light from a side of the first substrate.

The present invention further provides a sixth method of manufacturing a one drop fill liquid crystal display panel, including the steps of: providing a first substrate and a second substrate, the first substrate having a first central region and a first peripheral region, and the second substrate having a second central region and a second peripheral region, wherein a color pixel area and a black matrix area are positioned on the surface of the first central region, and the first central region and the first peripheral region are positioned opposite to the second central region and the second peripheral region respectively; forming a photo spacer area on the second peripheral region, wherein the photo spacer area is located opposite to the outside edge of the black matrix area; forming a sealant area on the second peripheral region, wherein the sealant area is located at the outside of the photo spacer area; dispersing at least one drop of a liquid crystal on the second central region; superposing the first substrate and the second substrate under a condition of reduced ambient air pressure; and curing the sealant area by applying ultraviolet light from a side of the first substrate.

The present invention further provides a seventh method of manufacturing a one drop fill liquid crystal display panel, including the steps of: providing a first substrate and a second substrate, the first substrate having a first central region and a first peripheral region, and the second substrate having a second central region and a second peripheral region, wherein a color pixel area and a black matrix area are positioned on the surface of the first central region, and the first central region and the first peripheral region are positioned opposite to the second central region and the second peripheral region respectively; forming a photo spacer area on the first peripheral region, wherein the photo spacer area is located at the outside of the black matrix area and separated from the black matrix area by a predetermined space; forming a sealant area on the first peripheral region, wherein the sealant area is located at the outside of the photo spacer area; dispersing at least one drop of a liquid crystal on the second central region; superposing the first substrate and the second substrate under a condition of reduced ambient air pressure; and curing the sealant area by applying ultraviolet light from a side of the first substrate.

The present invention further provides a eighth method of manufacturing a one drop fill liquid crystal display panel, including the steps of: providing a first substrate and a second substrate, the first substrate having a first central region and a first peripheral region, and the second substrate having a second central region and a second peripheral region, wherein a color pixel area and a black matrix area are positioned on the surface of the first central region, and the first central region and the first peripheral region are positioned opposite to the second central region and the second peripheral region respectively; forming a photo spacer area on the first peripheral region, wherein the photo spacer area is located at the outside of the black matrix area and separated from the black matrix area by a predetermined space; forming a sealant area on the second peripheral region, wherein the sealant area is located opposite to the outside of the photo spacer area; dispersing at least one drop of a liquid crystal on the second central region; superposing the first substrate and the second substrate under a condition of reduced ambient air pressure; and curing the sealant area by applying ultraviolet light from a side of the first substrate.

The present invention further provides a ninth method of manufacturing a one drop fill liquid crystal display panel, including the steps of: providing a first substrate and a second substrate, the first substrate having a first central region and a first peripheral region, and the second substrate having a second central region and a second peripheral region, wherein a color pixel area and a black matrix area are positioned on the surface of the first central region, and the first central region and the first peripheral region are positioned opposite to the second central region and the second peripheral region respectively; forming a photo spacer area on the second peripheral region, wherein the photo spacer area is located opposite to the outside of the black matrix area and separated from the black matrix area by a predetermined space; forming a sealant area on the first peripheral region, wherein the sealant area is located opposite to the outside of the photo spacer area; dispersing at least one drop of a liquid crystal on the second central region; superposing the first substrate and the second substrate under a condition of reduced ambient air pressure; and curing the sealant area by applying ultraviolet light from a side of the first substrate.

The present invention further provides a tenth method of manufacturing a one drop fill liquid crystal display panel, including the steps of: providing a first substrate and a second substrate, the first substrate having a first central region and a first peripheral region, and the second substrate having a second central region and a second peripheral region, wherein a color pixel area and a black matrix area are positioned on the surface of the first central region, and the first central region and the first peripheral region are positioned opposite to the second central region and the second peripheral region respectively; forming a photo spacer area on the second peripheral region, wherein the photo spacer area is located opposite to the outside of the black matrix area and separated from the black matrix area by a predetermined space; forming a sealant area on the second peripheral region, wherein the sealant area is located at the outside of the photo spacer area; dispersing at least one drop of a liquid crystal on the second central region; superposing the first substrate and the second substrate under a condition of reduced ambient air pressure; and curing the sealant area by applying ultraviolet light from a side of the first substrate.

By separating sealant and black matrix using a space or photo spacer according to above methods, the sealant can be hardened by applying ultraviolet light from the side of the color filter substrate without light shielding problems. Moreover, this also completely hardens the sealant, thereby preventing pollution of the liquid crystal material. This further improves the efficiency of the liquid crystal material.

### BRIEF DESCRIPTION OF THE DRAWINGS

The present invention can be more fully understood by reading the subsequent detailed description in conjunction with the examples and references made to the accompanying drawings, wherein:

FIG. 1a is a perspective view showing a conventional ODF LCD panel, and FIG. 1b is a sectional view showing the conventional ODF LCD panel of FIG. 1a;

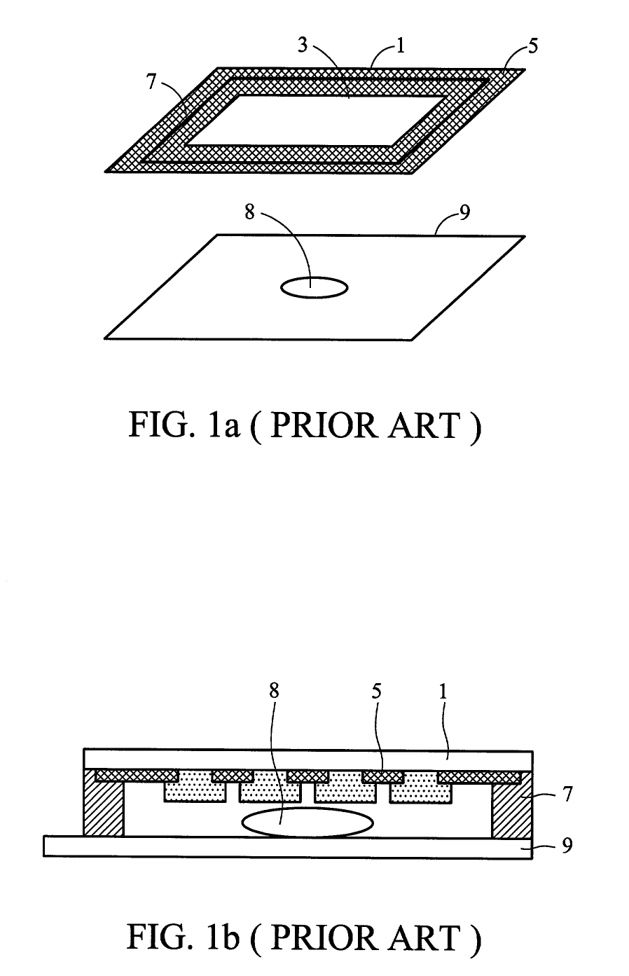

FIG. 2a is a perspective view showing an ODF LCD panel of the first embodiment of the present invention, and FIG. 2b is a sectional view showing the ODF LCD panel of FIG. 2a;

FIG. 3a is a perspective view showing an ODF LCD panel of the second embodiment of the present invention, and FIG. 3b is a sectional view showing the ODF LCD panel of FIG. 3a;

FIG. 4a is a perspective view showing an ODF LCD panel of the third embodiment of the present invention, and FIG. 4b is a sectional view showing the ODF LCD panel of FIG. 4a;

FIG. 5a is a perspective view showing an ODF LCD panel of the fourth embodiment of the present invention, and FIG. 5b is a sectional view showing the ODF LCD panel of FIG. 5a;

FIG. 6a is a perspective view showing an ODF LCD panel of the fifth embodiment of the present invention, and FIG. 6b is a sectional view showing the ODF LCD panel of FIG. 6a;

FIG. 7a is a perspective view showing an ODF LCD panel of the sixth embodiment of the present invention, and FIG. 7b is a sectional view showing the ODF LCD panel of FIG. 7a;

FIG. 8a is a perspective view showing an ODF LCD panel of the seventh embodiment of the present invention, and FIG. 8b is a sectional view showing the ODF LCD panel of FIG. 8a;

FIG. 9a is a perspective view showing an ODF LCD panel of the eighth embodiment of the present invention, and FIG. 9b is a sectional view showing the ODF LCD panel of FIG. 9a;

FIG. 10a is a perspective view showing an ODF LCD panel of the ninth embodiment of the present invention, and FIG. 10b is a sectional view showing the ODF LCD panel of FIG. 10a; and

FIG. 11a is a perspective view showing an ODF LCD panel of the tenth embodiment of the present invention, and FIG. 11b is a sectional view showing the ODF LCD panel of FIG. 11a;

### DETAILED DESCRIPTION OF THE PREFERRED EMBODIMENT

First Embodiment

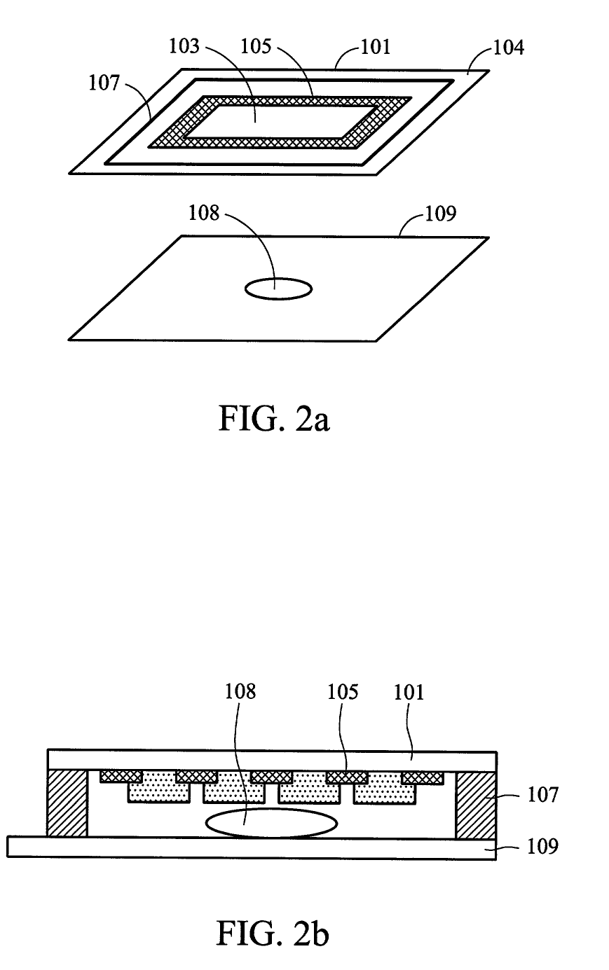

Refer to FIGS. 2a and 2b. A color pixel area 103 and a black matrix area 105 are preformed on a color filter substrate 101. First, as shown in FIG. 2a, a sealant area 107 is formed on a peripheral region 104 of the color filter substrate 101, and the sealant area 107 is separated from the black matrix area 105 by a predetermined space. Secondly, at least one drop of a liquid crystal 108 is dripped down on an array substrate 109. Next, the color filter substrate 101 and the array substrate 109 are superposed face-to-face as shown in FIG. 2a under a vacuum condition. Further, the sealant area 107 is cured by applying ultraviolet light from a side of the color filter substrate 101, and then an ODF LCD panel as shown in FIG. 2b is obtained.

According to FIG. 2b, because the sealant area 107 and the black matrix area 105 are separated by the space, the sealant area 107 is completely hardened while applying ultraviolet light from the side of the color filter substrate 101 without the light shielding problems resulting from the black matrix area 105.

Furthermore, the above liquid crystal 108, for example, is a mixture, and the mixture is preferably composed of liquid crystal materials and spacers.

Second Embodiment

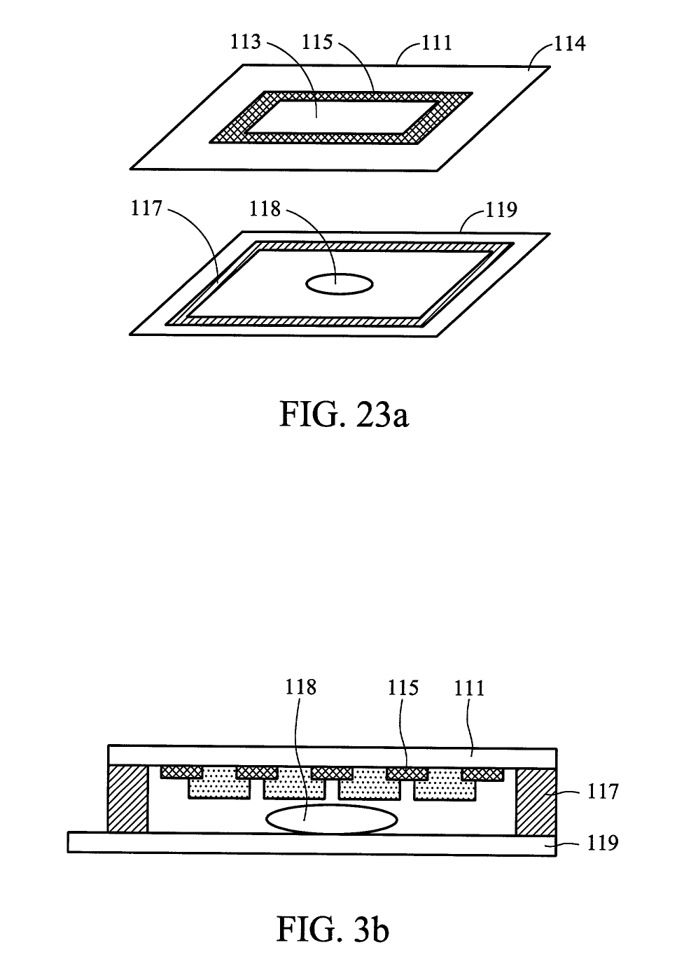

Refer to FIGS. 3a and 3b. A color pixel area 113 and a black matrix area 115 are preformed on a color filter substrate 111. First, as shown in FIG. 3a, a sealant area 117 is formed on an array substrate 119. The sealant area 117 is located at a position opposite to the outside of the black matrix area 115 and separated from the black matrix area 115 by a predetermined space. Secondly, at least one drop of a liquid crystal 118 is dripped down on the array substrate 119. Next, the color filter substrate 111 and the array substrate 119 are superposed face-to-face as shown in FIG. 3a under a vacuum condition. Further, the sealant area 117 is cured by applying ultraviolet light from a side of the color filter substrate 111, and then an ODF LCD panel as shown in FIG. 3b is obtained.

According to FIG. 3b, because the sealant area 117 and the black matrix area 115 are separated by the space, the sealant area 117 is completely hardened while applying ultraviolet light from the side of the color filter substrate 111 without the light shielding problems resulting from the black matrix area 115.

Furthermore, the above liquid crystal 118, for example, is a mixture, and the mixture is preferably composed of liquid crystal materials and spacers.

Third Embodiment

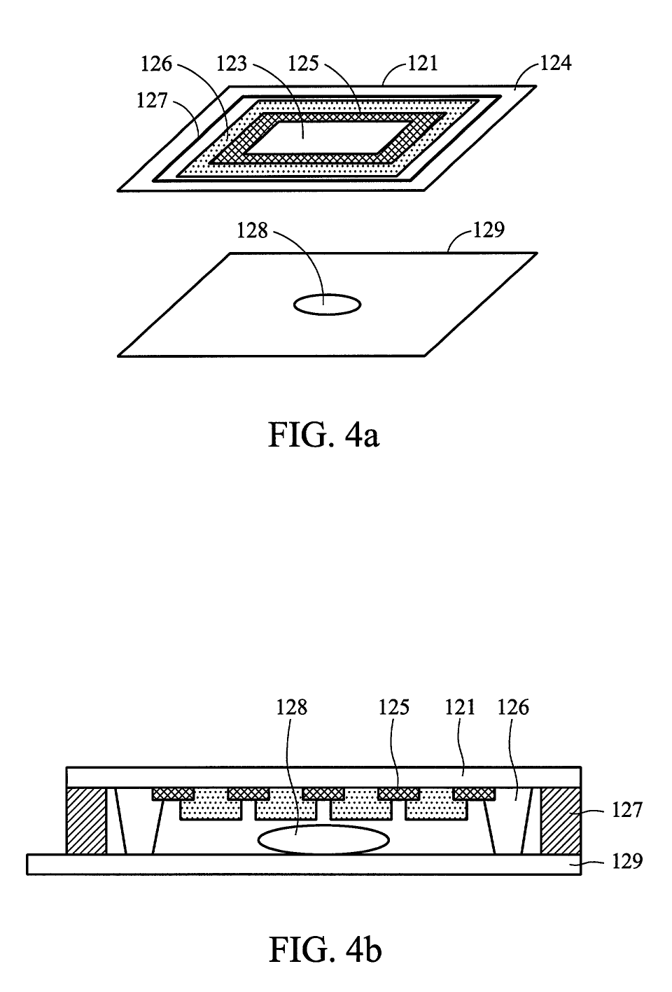

Refer to FIGS. 4a and 4b. A color pixel area 123 and a black matrix area 125 are preformed on a color filter substrate 121. First, as shown in FIG. 4a, a photo spacer area 126 is formed on a outside edge of the black matrix area 125, wherein the photo spacer area 126 overlaps the outside edge of the black matrix area 125. Secondly, a sealant area 127 is formed on a peripheral region 124 of the color filter substrate 121, and the sealant area 127 is located at the outside of the photo spacer area 126. Next, at least one drop of a liquid crystal 128 is dripped down on an array substrate 129. Moreover, the color filter substrate 121 and the array substrate 129 are superposed face-to-face as shown in FIG. 4a under a vacuum condition. Further, the sealant area 127 is cured by applying ultraviolet light from a side of the color filter substrate 121, and then an ODF LCD panel as shown in FIG. 4b is obtained.

According to FIG. 4b, because the sealant area 127 and the black matrix area 125 are separated by the photo spacer area 126, the sealant area 127 is completely hardened while applying ultraviolet light from the side of the color filter substrate 121 without the light shielding problems resulting from the black matrix area 125. Moreover, this also completely hardens the sealant area 127, thereby preventing pollution of the liquid crystal 128. This further improves the efficiency of the liquid crystal 128.

Furthermore, the above liquid crystal 128, for example, is a mixture, and the mixture is preferably composed of liquid crystal materials and spacers.

Fourth Embodiment

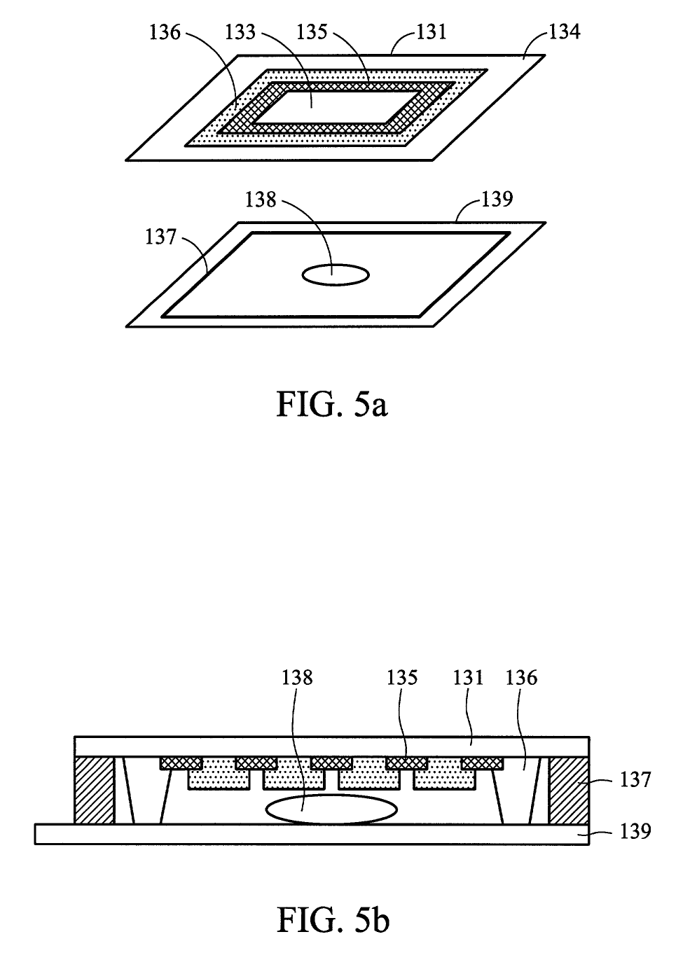

Refer to FIGS. 5a and 5b. A color pixel area 133 and a black matrix area 135 are preformed on a color filter substrate 131. First, as shown in FIG. 5a, a photo spacer area 136 is formed on an outside edge of the black matrix area 135, wherein the photo spacer area 136 overlaps the outside edge of the black matrix area 135. Secondly, a sealant area 137 is formed on an array substrate 139, wherein the sealant area 137 is located at a position opposite to the outside of the photo spacer area 136. Next, at least one drop of a liquid crystal 138 is dripped down on the array substrate 139. Moreover, the color filter substrate 131 and the array substrate 139 are superposed face-to-face as shown in FIG. 5a under a vacuum condition. Further, the sealant area 137 is cured by applying ultraviolet light from a side of the color filter substrate 131, and then an ODF LCD panel as shown in FIG. 5b is obtained.

According to FIG. 5b, because the sealant area 137 and the black matrix area 135 are separated by the photo spacer area 136, the sealant area 137 is completely hardened while applying ultraviolet light from the side of the color filter substrate 131 without the light shielding problems resulting from the black matrix area 135. Moreover, this also completely hardens the sealant area 137, thereby preventing pollution of the liquid crystal 138. This further improves the efficiency of the liquid crystal 138.

Furthermore, the above liquid crystal 138, for example, is a mixture, and the mixture is preferably composed of liquid crystal materials and spacers.

Fifth Embodiment

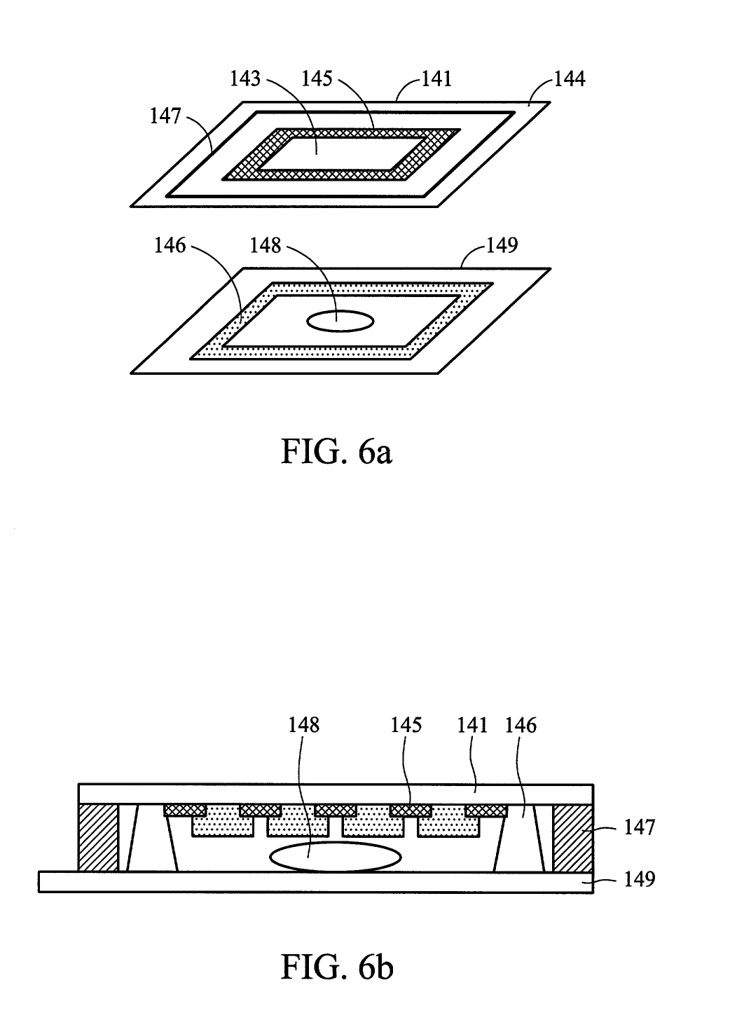

Refer to FIGS. 6a and 6b. A color pixel area 143 and a black matrix area 145 are preformed on a color filter substrate 141. First, as shown in FIG. 6a, a photo spacer area 146 is formed on an array substrate 149, wherein the photo spacer area 146 is located at a first position opposite to the outside edge of the black matrix area 145. Secondly, a sealant area 147 is formed on a peripheral region 144 of the color filter substrate 141, wherein the sealant area 147 is located at a second position opposite to the outside of the photo spacer area 146. Next, at least one drop of a liquid crystal 148 is dripped down on the array substrate 149. Moreover, the color filter substrate 141 and the array substrate 149 are superposed face-to-face as shown in FIG. 6a under a vacuum condition. Further, the sealant area 147 is cured by applying ultraviolet light from a side of the color filter substrate 141, and then an ODF LCD panel as shown in FIG. 6b is obtained.

According to FIG. 6b, because the sealant area 147 and the black matrix area 145 are separated by the photo spacer area 146, the sealant area 147 is completely hardened while applying ultraviolet light from the side of the color filter substrate 141 without the light shielding problems resulting from the black matrix area 145. Moreover, this also completely hardens the sealant area 147, thereby preventing pollution of the liquid crystal 148. This further improves the efficiency of the liquid crystal 148.

Furthermore, the above liquid crystal 148, for example, is a mixture, and the mixture is preferably composed of liquid crystal materials and spacers.

Sixth Embodiment

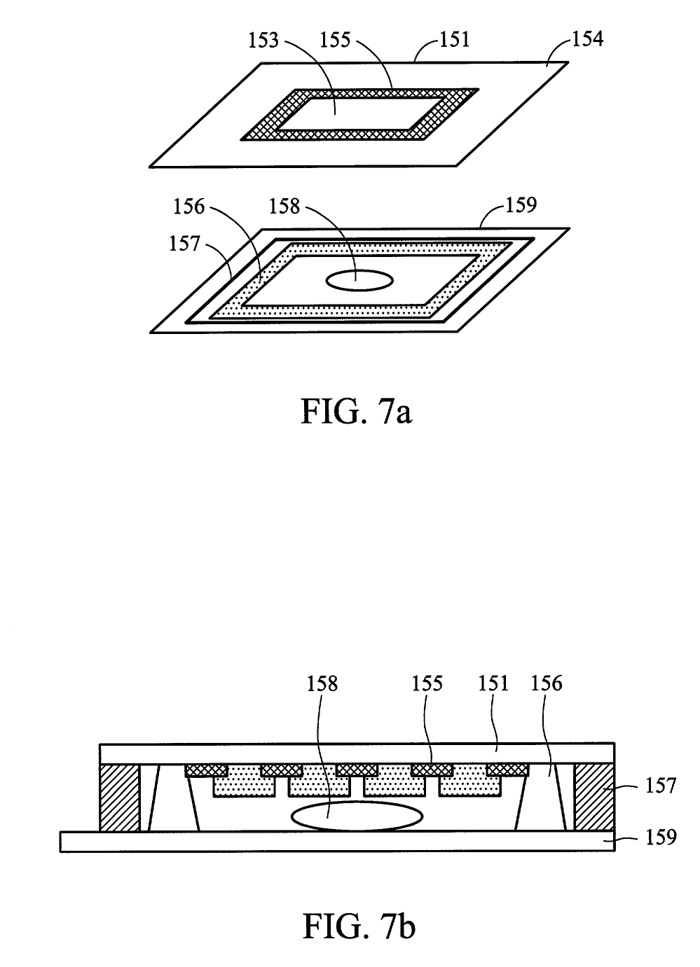

Refer to FIGS. 7a and 7b. A color pixel area 153 and a black matrix area 155 are preformed on a color filter substrate 151. First, as shown in FIG. 7a, a photo spacer area 156 is formed on an array substrate 159, wherein the photo spacer area 156 is located at a position opposite to the outside edge of the black matrix area 155. Secondly, a sealant area 157 is formed on the array substrate 159, wherein the sealant area 157 is located at the outside of the photo spacer area 156. Next, at least one drop of a liquid crystal 158 is dripped down on the array substrate 159. Moreover, the color filter substrate 151 and the array substrate 159 are superposed face-to-face as shown in FIG. 7a under a vacuum condition. Further, the sealant area 157 is cured by applying ultraviolet light from a side of the color filter substrate 151, and then an ODF LCD panel as shown in FIG. 7b is obtained.

According to FIG. 7b, because the sealant area 157 and the black matrix area 155 are separated by the photo spacer area 156, the sealant area 157 is completely hardened while applying ultraviolet light from the side of the color filter substrate 151 without the light shielding problems resulting from the black matrix area 155. Moreover, this also completely hardens the sealant area 157, thereby preventing pollution of the liquid crystal 158. This further improves the efficiency of the liquid crystal 158.

Furthermore, the above liquid crystal 158, for example, is a mixture, and the mixture is preferably composed of liquid crystal materials and spacers.

Seventh Embodiment

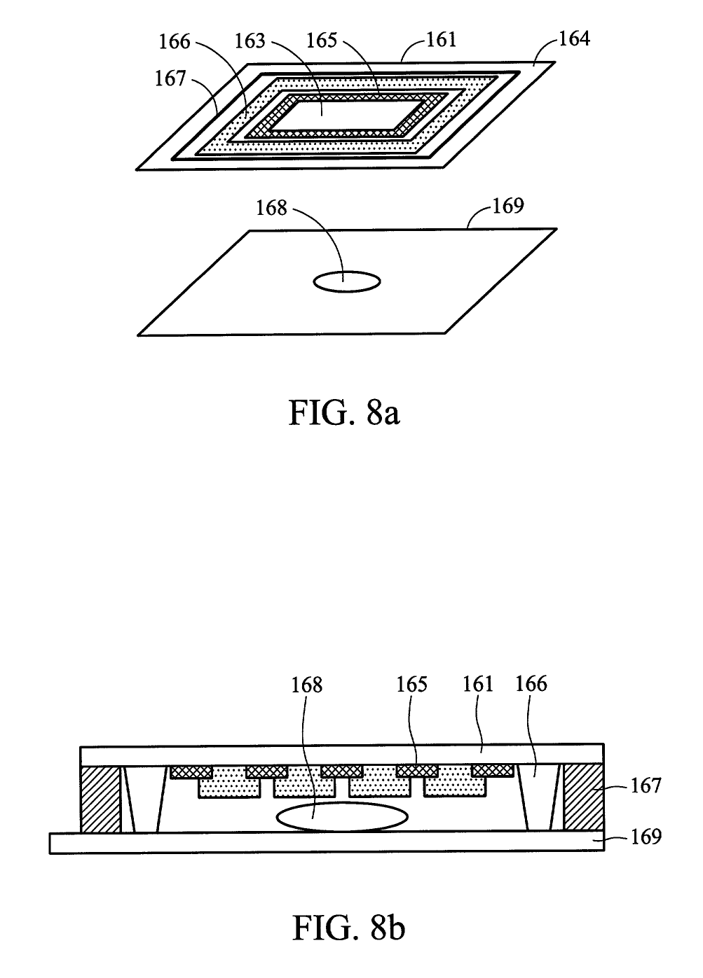

Refer to FIGS. 8a and 8b. A color pixel area 163 and a black matrix area 165 are preformed on a color filter substrate 161. First, as shown in FIG. 8a, a photo spacer area 166 is formed on a peripheral region 164 of the color filter substrate 161. The photo spacer area 166 is located at the outside of the black matrix area 165 and is separated from the black matrix area 165 by a predetermined space. Secondly, a sealant area 167 is formed on the peripheral region 164, and the sealant area 167 is located at the outside of the photo spacer area 166. Next, at least one drop of a liquid crystal 168 is dripped down on an array substrate 169. Moreover, the color filter substrate 161 and the array substrate 169 are superposed face-to-face as shown in FIG. 8a under a vacuum condition. Further, the sealant area 167 is cured by applying ultraviolet light from a side of the color filter substrate 161, and then an ODF LCD panel as shown in FIG. 8b is obtained.

According to FIG. 8b, because the sealant area 167 and the black matrix area 165 are separated by the photo spacer area 166, the sealant area 167 is completely hardened while applying ultraviolet light from the side of the color filter substrate 161 without the light shielding problems resulting from the black matrix area 165. Moreover, this also completely hardens the sealant area 167, thereby preventing pollution of the liquid crystal 168. This further improves the efficiency of the liquid crystal 168.

Furthermore, the above liquid crystal 168, for example, is a mixture, and the mixture is preferably composed of liquid crystal materials and spacers.

Eighth Embodiment

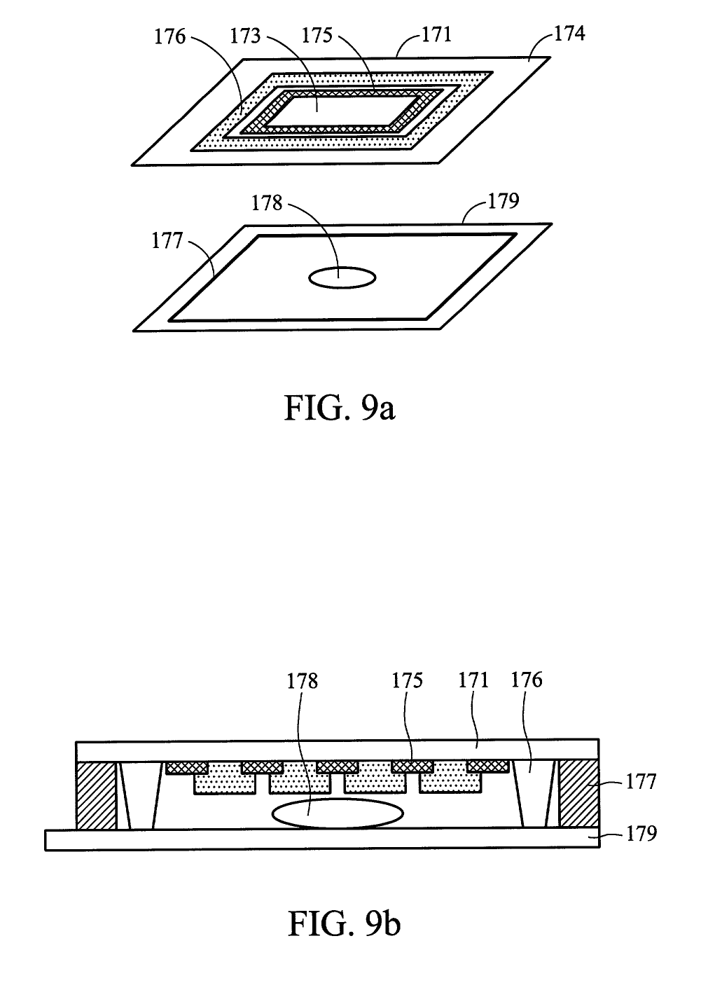

Refer to FIGS. 9a and 9b. A color pixel area 173 and a black matrix area 175 are preformed on a color filter substrate 171. First, as shown in FIG. 9a, a photo spacer area 176 is formed on a peripheral region 174 of the color filter substrate 171. The photo spacer area 176 is located at the outside of the black matrix area 175 and is separated from the black matrix area 175 by a predetermined space. Secondly, a sealant area 177 is formed on an array substrate 179, wherein the sealant area 177 is located at a position opposite to the outside of the photo spacer area 176. Next, at least one drop of a liquid crystal 178 is dripped down on the array substrate 179. Moreover, the color filter substrate 171 and the array substrate 179 are superposed face-to-face as shown in FIG. 9a under a vacuum condition. Further, the sealant area 177 is cured by applying ultraviolet light from a side of the color filter substrate 171, and then an ODF LCD panel as shown in FIG. 9b is obtained.

According to FIG. 9b, because the sealant area 177 and the black matrix area 175 are separated by the photo spacer area 176, the sealant area 177 is completely hardened while applying ultraviolet light from the side of the color filter substrate 171 without the light shielding problems resulting from the black matrix area 175. Moreover, this also completely hardens the sealant area 177, thereby preventing pollution of the liquid crystal 178. This further improves the efficiency of the liquid crystal 178.

Furthermore, the above liquid crystal 178, for example, is a mixture, and the mixture is preferably composed of liquid crystal materials and spacers.

Ninth Embodiment

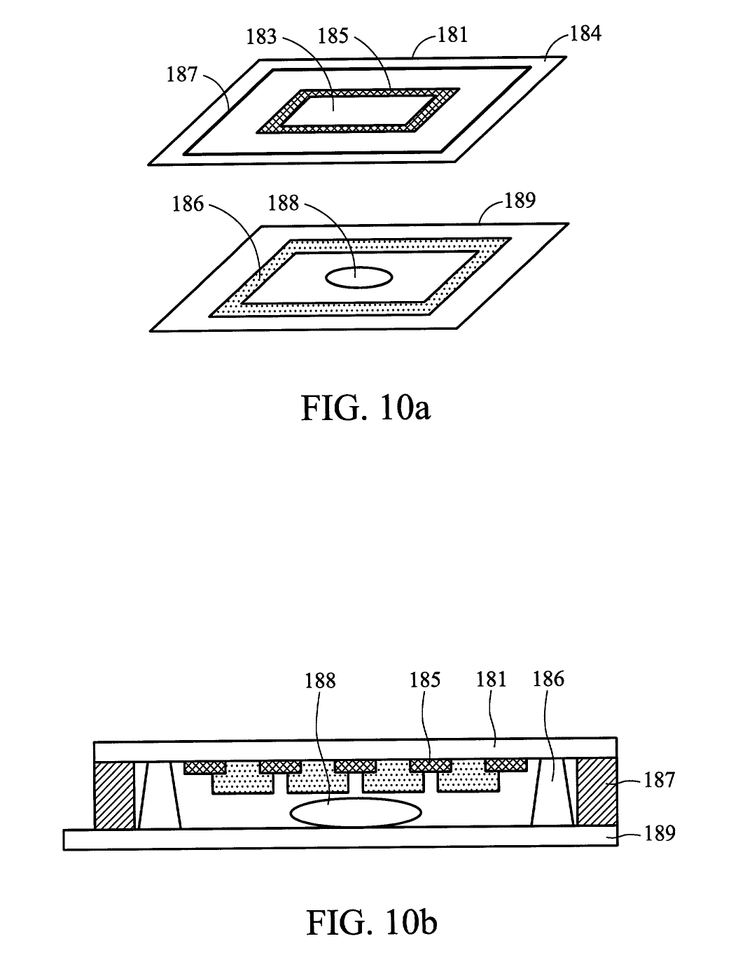

Refer to FIGS. 10a and 10b. A color pixel area 183 and a black matrix area 185 are preformed on a color filter substrate 181. First, as shown in FIG. 10a, a photo spacer area 186 is formed on an array substrate 189. The photo spacer area 186 is located at a position opposite to the outside of the black matrix area 185 and is separated from the black matrix area 185 by a predetermined space. Secondly, a sealant area 187 is formed on a peripheral region 184 of the color filter substrate 181, and the sealant area 187 is located at a position opposite to the outside of the photo spacer area 186. Next, at least one drop of a liquid crystal 188 is dripped down on the array substrate 189. Moreover, the color filter substrate 181 and the array substrate 189 are superposed face-to-face as shown in FIG. 10a under a vacuum condition. Further, the sealant area 187 is cured by applying ultraviolet light from a side of the color filter substrate 181, and then an ODF LCD panel as shown in FIG. 10b is obtained.

According to FIG. 10b, because the sealant area 187 and the black matrix area 185 are separated by the photo spacer area 186, the sealant area 187 is completely hardened while applying ultraviolet light from the side of the color filter substrate 181 without the light shielding problems resulting from the black matrix area 185. Moreover, this also completely hardens the sealant area 187, thereby preventing pollution of the liquid crystal 188. This further improves the efficiency of the liquid crystal 188.

Furthermore, the above liquid crystal 188, for example, is a mixture, and the mixture is preferably composed of liquid crystal materials and spacers.

Tenth Embodiment

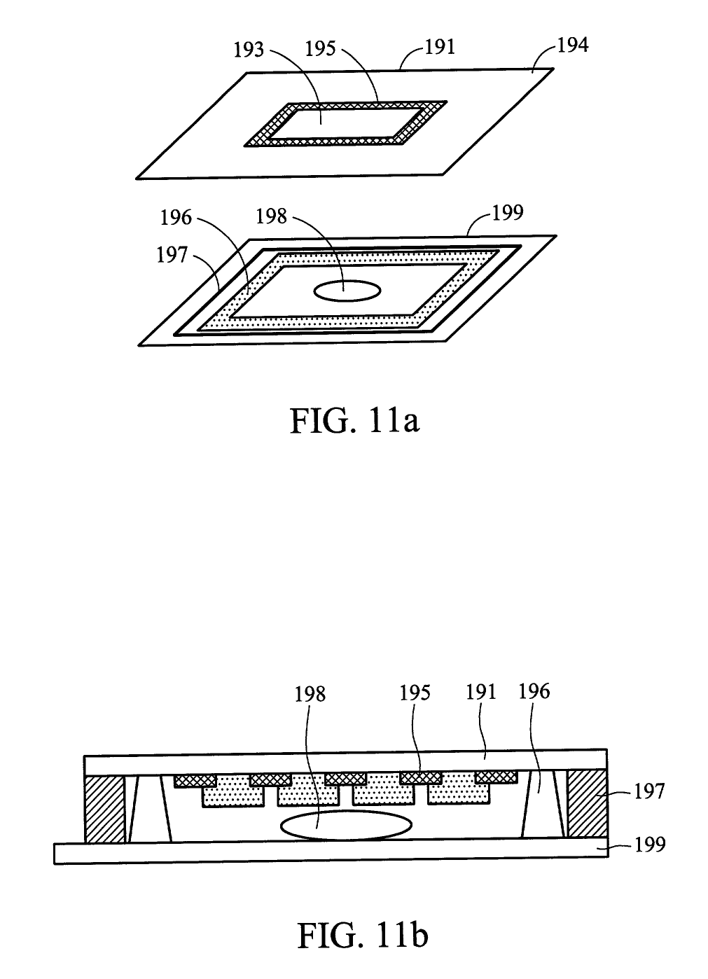

Refer to FIGS. 11a and 11b. A color pixel area 193 and a black matrix area 195 are preformed on a color filter substrate 191. First, as shown in FIG. 11a, a photo spacer area 196 is formed on an array substrate 199. The photo spacer area 196 is located at a position opposite to the outside of the black matrix area 195 and is separated from the black matrix area 195 by a predetermined space. Secondly, a sealant area 197 is formed on the array substrate 199, and the sealant area 197 is located at the outside of the photo spacer area 196. Next, at least one drop of a liquid crystal 198 is dripped down on the array substrate 199. Moreover, the color filter substrate 191 and the array substrate 199 are superposed face-to-face as shown in FIG. 11a under a vacuum condition. Further, the sealant area 197 is cured by applying ultraviolet light from a side of the color filter substrate 191, and then an ODF LCD panel as shown in FIG. 11b is obtained.

According to FIG. 11b, because the sealant area 197 and the black matrix area 195 is separated by the photo spacer area 196, the sealant area 197 is completely hardened while applying ultraviolet light from the side of the color filter substrate 191 without the light shielding problems resulting from the black matrix area 195. Moreover, this also completely hardens the sealant area 197, thereby preventing pollution of the liquid crystal 198. This further improves the efficiency of the liquid crystal 198.

Furthermore, the above liquid crystal 198, for example, is a mixture, and the mixture is preferably composed of liquid crystal materials and spacers.

Finally, while the invention has been described by way of example and in terms of the preferred embodiment, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method of manufacturing a one drop fill liquid crystal display panel, comprising the steps of:
providing a first substrate and a second substrate, the first substrate having a first central region and a first peripheral region, and the second substrate having a second central region and a second peripheral region, wherein a color pixel area and a black matrix area are positioned on the surface of the first central region, and the first central region and the first peripheral region are positioned opposite to the second central region and the second peripheral region respectively;
forming a sealant area on the first peripheral region, wherein the sealant area is located at the outside of the black matrix area and separated from the black matrix area by a predetermined space;
dispersing at least one drop of a liquid crystal on the second central region;
superposing the first substrate and the second substrate under a condition of reduced ambient air pressure; and
curing the sealant area by applying ultraviolet light from a side of the first substrate.

2. The method of manufacturing a one drop fill liquid crystal display panel as claimed in claim 1, wherein the liquid crystal is a mixture composed of liquid crystal materials and spacers.

3. A method of manufacturing a one drop fill liquid crystal display panel, comprising the steps of:
providing a first substrate and a second substrate, the first substrate having a first central region and a first peripheral region, and the second substrate having a second central region and a second peripheral region, wherein a color pixel area and a black matrix area are positioned on the surface of the first central region, and the first central region and the first peripheral region are positioned opposite to the second central region and the second peripheral region respectively;
forming a sealant area on the second peripheral region, wherein the sealant area is located opposite to the outside of the black matrix area and separated from the black matrix area by a predetermined space;
dispersing at least one drop of a liquid crystal on the second central region;
superposing the first substrate and the second substrate under a condition of reduced ambient air pressure; and
curing the sealant area by applying ultraviolet light from a side of the first substrate.

4. The method of manufacturing a one drop fill liquid crystal display panel as claimed in claim 3, wherein the liquid crystal is a mixture composed of liquid crystal materials and spacers.

5. A method of manufacturing a one drop fill liquid crystal display panel, comprising the steps of:
providing a first substrate and a second substrate, the first substrate having a first central region and a first peripheral region, and the second substrate having a second central region and a second peripheral region, wherein a color pixel area and a black matrix area are positioned on the surface of the first central region, and the first central region and the first peripheral region are positioned opposite to the second central region and the second peripheral region respectively;
forming a photo spacer area on the first peripheral region, wherein the photo spacer area overlaps the outside edge of the black matrix area;
forming a sealant area on the first peripheral region, wherein the sealant area is located at the outside of the photo spacer area;
dispersing at least one drop of a liquid crystal on the second central region;
superposing the first substrate and the second substrate under a condition of reduced ambient air pressure; and
curing the sealant area by applying ultraviolet light from a side of the first substrate.

6. The method of manufacturing a one drop fill liquid crystal display panel as claimed in claim 5, wherein the liquid crystal is a mixture composed of liquid crystal materials and spacers.

7. A method of manufacturing a one drop fill liquid crystal display panel, comprising the steps of:
providing a first substrate and a second substrate, the first substrate having a first central region and a first peripheral region, and the second substrate having a second central region and a second peripheral region, wherein a color pixel area and a black matrix area are positioned on the surface of the first central region, and the first central region and the first peripheral region are positioned opposite to the second central region and the second peripheral region respectively;
forming a photo spacer area on the first peripheral region, wherein the photo spacer area overlaps the outside edge of the black matrix area;
forming a sealant area on the second peripheral region, wherein the sealant area is located opposite to the outside of the photo spacer area;
dispersing at least one drop of a liquid crystal on the second central region;
superposing the first substrate and the second substrate under a condition of reduced ambient air pressure; and
curing the sealant area by applying ultraviolet light from a side of the first substrate.

8. The method of manufacturing a one drop fill liquid crystal display panel as claimed in claim 7, wherein the liquid crystal is a mixture composed of liquid crystal materials and spacers.

9. A method of manufacturing a one drop fill liquid crystal display panel, comprising the steps of:
providing a first substrate and a second substrate, the first substrate having a first central region and a first peripheral region, and the second substrate having a second central region and a second peripheral region, wherein a color pixel area and a black matrix area are positioned on the surface of the first central region, and the first central region and the first peripheral region are positioned opposite to the second central region and the second peripheral region respectively;
forming a photo spacer area on the second peripheral region, wherein the photo spacer area is located at a first position opposite to the outside edge of the black matrix area;
forming a sealant area on the first peripheral region, wherein the sealant area is located at a second position opposite to the outside of the photo spacer area;
dispersing at least one drop of a liquid crystal on the second central region;
superposing the first substrate and the second substrate under a condition of reduced ambient air pressure; and
curing the sealant area by applying ultraviolet light from a side of the first substrate.

10. The method of manufacturing a one drop fill liquid crystal display panel as claimed in claim 9, wherein the liquid crystal is a mixture composed of liquid crystal materials and spacers.

11. A method of manufacturing a one drop fill liquid crystal display panel, comprising the steps of:
providing a first substrate and a second substrate, the first substrate having a first central region and a first peripheral region, and the second substrate having a second central region and a second peripheral region, wherein a color pixel area and a black matrix area are positioned on the surface of the first central region, and the first central region and the first peripheral region are positioned opposite to the second central region and the second peripheral region respectively;
forming a photo spacer area on the second peripheral region, wherein the photo spacer area is located opposite to the outside edge of the black matrix area;
forming a sealant area on the second peripheral region, wherein the sealant area is located at the outside of the photo spacer area;
dispersing at least one drop of a liquid crystal on the second central region;
superposing the first substrate and the second substrate under a condition of reduced ambient air pressure; and
curing the sealant area by applying ultraviolet light from a side of the first substrate.

12. The method of manufacturing a one drop fill liquid crystal display panel as claimed in claim 11, wherein the liquid crystal is a mixture composed of liquid crystal materials and spacers.

13. A method of manufacturing a one drop fill liquid crystal display panel, comprising the steps of:
providing a first substrate and a second substrate, the first substrate having a first central region and a first peripheral region, and the second substrate having a second central region and a second peripheral region, wherein a color pixel area and a black matrix area are positioned on the surface of the first central region, and the first central region and the first peripheral region are positioned opposite to the second central region and the second peripheral region respectively;
forming a photo spacer area on the first peripheral region, wherein the photo spacer area is located at the outside of the black matrix area and separated from the black matrix area by a predetermined space;
forming a sealant area on the first peripheral region, wherein the sealant area is located at the outside of the photo spacer area;
dispersing at least one drop of a liquid crystal on the second central region;
superposing the first substrate and the second substrate under a condition of reduced ambient air pressure; and
curing the sealant area by applying ultraviolet light from a side of the first substrate.

14. The method of manufacturing a one drop fill liquid crystal display panel as claimed in claim 13, wherein the liquid crystal is a mixture composed of liquid crystal materials and spacers.

15. A method of manufacturing a one drop fill liquid crystal display panel, comprising the steps of:
providing a first substrate and a second substrate, the first substrate having a first central region and a first peripheral region, and the second substrate having a second central region and a second peripheral region, wherein a color pixel area and a black matrix area are positioned on the surface of the first central region, and the first central region and the first peripheral region are positioned opposite to the second central region and the second peripheral region respectively;
forming a photo spacer area on the first peripheral region, wherein the photo spacer area is located at the outside of the black matrix area and separated from the black matrix area by a predetermined space;
forming a sealant area on the second peripheral region, wherein the sealant area is located opposite to the outside of the photo spacer area;
dispersing at least one drop of a liquid crystal on the second central region;
superposing the first substrate and the second substrate under a condition of reduced ambient air pressure; and
curing the sealant area by applying ultraviolet light from a side of the first substrate.

16. The method of manufacturing a one drop fill liquid crystal display panel as claimed in claim 15, wherein the liquid crystal is a mixture composed of liquid crystal materials and spacers.

17. A method of manufacturing a one drop fill liquid crystal display panel, comprising the steps of:
providing a first substrate and a second substrate, the first substrate having a first central region and a first peripheral region, and the second substrate having a second central region and a second peripheral region, wherein a color pixel area and a black matrix area are positioned on the surface of the first central region, and the first central region and the first peripheral region are positioned opposite to the second central region and the second peripheral region respectively;
forming a photo spacer area on the second peripheral region, wherein the photo spacer area is located opposite to the outside of the black matrix area and separated from the black matrix area by a predetermined space;
forming a sealant area on the first peripheral region, wherein the sealant area is located opposite to the outside of the photo spacer area;
dispersing at least one drop of a liquid crystal on the second central region;
superposing the first substrate and the second substrate under a condition of reduced ambient air pressure; and
curing the sealant area by applying ultraviolet light from a side of the first substrate.

18. The method of manufacturing a one drop fill liquid crystal display panel as claimed in claim 17, wherein the liquid crystal is a mixture composed of liquid crystal materials and spacers.

19. A method of manufacturing a one drop fill liquid crystal display panel, comprising the steps of:
providing a first substrate and a second substrate, the first substrate having a first central region and a first peripheral region, and the second substrate having a second central region and a second peripheral region, wherein a color pixel area and a black matrix area are positioned on the surface of the first central region, and the first central region and the first peripheral region are positioned opposite to the second central region and the second peripheral region respectively;
forming a photo spacer area on the second peripheral region, wherein the photo spacer area is located opposite to the outside of the black matrix area and separated from the black matrix area by a predetermined space;
forming a sealant area on the second peripheral region, wherein the sealant area is located at the outside of the photo spacer area;
dispersing at least one drop of a liquid crystal on the second central region;
superposing the first substrate and the second substrate under a condition of reduced ambient air pressure; and
curing the sealant area by applying ultraviolet light from a side of the first substrate.

20. The method of manufacturing a one drop fill liquid crystal display panel as claimed in claim 19, wherein the liquid crystal is a mixture composed of liquid crystal materials and spacers.
